(19) United States
(12) Patent Application Publication
(10) Pub. No.: US 2026/0090524 A1
(43) Pub. Date: Apr. 2, 2026

(54) Peeping Chicken Feeder

(71) Applicant: LEONARDO COBO, Houston, TX (US)

(72) Inventor: LEONARDO COBO, Houston, TX (US)

(21) Appl. No.: 18/902,843

(22) Filed: Sep. 30, 2024

(51) Int. Cl. A01K 39/01

(52) U.S. Cl. CPC A01K 39/0113

(57) ABSTRACT

A poultry feeder includes a tubular main body (1) with curved slot holes (6) at a uniform height, elevated above the ground by adjustable brackets (2) and feet (22, 24). A curved cover (12) overlies the slot holes (6) and is connected to tension springs (10). Treadles (7) on either side are pivotally mounted and connected via chains (15), cables (18), and pulleys (19) to the cover (12). When a bird of sufficient weight steps on a treadle (7), the mechanism lifts the cover (12) to expose the feed reservoir (5). When the bird steps off, the springs (10) return the cover (12) to a closed position, preventing access by small birds or rodents. The feeder includes a weather-resistant inverted V-shaped roof (28) with hinged panels (29) for protection, portability, and compact storage. The design provides regulated feed access, pest protection, and environmental shielding for chickens, ducks, turkeys, and other fowl.

### SUMMARY OF THE INVENTION

FIG. 4 shows a design invented to feed domesticated chickens, when they want to eat any time and keeping rodent species away from the food such as rats, mice, squirrels, possum, raccoon, birds, etc. This helps to keep the cost of feeding your chickens down. Peeping Chicken Feeder is mobile and it can feed around 3 to 5 chickens or more, covering an area around 4.5 sq ft on the ground. see views on FIG. 10, FIG. 11, and FIG. 12. Peeping chicken feeder is a system that works on its own not maintenance required, just refeel the food storage when it needs, owners can fill out the food storage every week depending how many chickens they have, counting for 3-4 chickens. FIG. 5 showed all components, this system has the support or structure, roof, and the operational mechanical system, additional components are shown in FIG. 6 and FIG. 9. Chickens have sense to recognize very quick where is the food FIG. 7, it takes approximately a week or less to learn where is the location for the food, steps on the pedals, and last ones is familiarizing with the Peeping Chicken Feeder when cover food rise up and go down. FIG. 4 shows when chickens step down on pedals, the food cover rises up, there are spring systems and allowed to extend to move the cover up, and each pedal works independently. When chickens are moving out of the Peeping Chicken Feeder see FIG. 8 the spring system pulls down the food cover and remains close and pedals go up.

This invention is already finished and multiple prototypes have been built. Other support documents including pictures or videos are available. Also, the mechanic system can be modified for other pets, including dogs and cats.

Peeping Chicken Feeder works depending on the weight of the chicken at a minimum of 2.5 pounds, the spring system is calibrated according to the size and weight of animal being feed

### DESCRIPTION OF THE DRAWINGS

Peeping chicken feeders are built with three components, FIG. 1 claim 1, FIG. 2 claim 2, and FIG. 3 claim 3.

FIG. 4 shows a design invented to feed domesticated chickens. It allows them to eat at any time and helps to keep rodents away from the food such as rats, mice, squirrels, possums, raccoons, birds, etc.

FIG. 5 shows Peeping Chicken Feeder is a system that works on its own with no maintenance. Only requiring refilling the food storage container when needed. FIG. 6 shows a food storage can be filled daily or weekly, depending on the number of chickens you have.

FIG. 7 shows how chickens quickly recognize where the food is, it generally takes less than a week for them to learn the system. FIG. 4 shows when a chicken steps on the pedal, the cover of the Peeping Chicken Feeder will rise, allowing access for the chickens to the food, FIG. 8 shows when the chicken steps off of the pedal, the spring loaded mechanics closes the cover to prevent other animals from accessing the food. The system works in response to the chickens weight and each pedal is independent of each other. That way more chickens can feed at the same time.

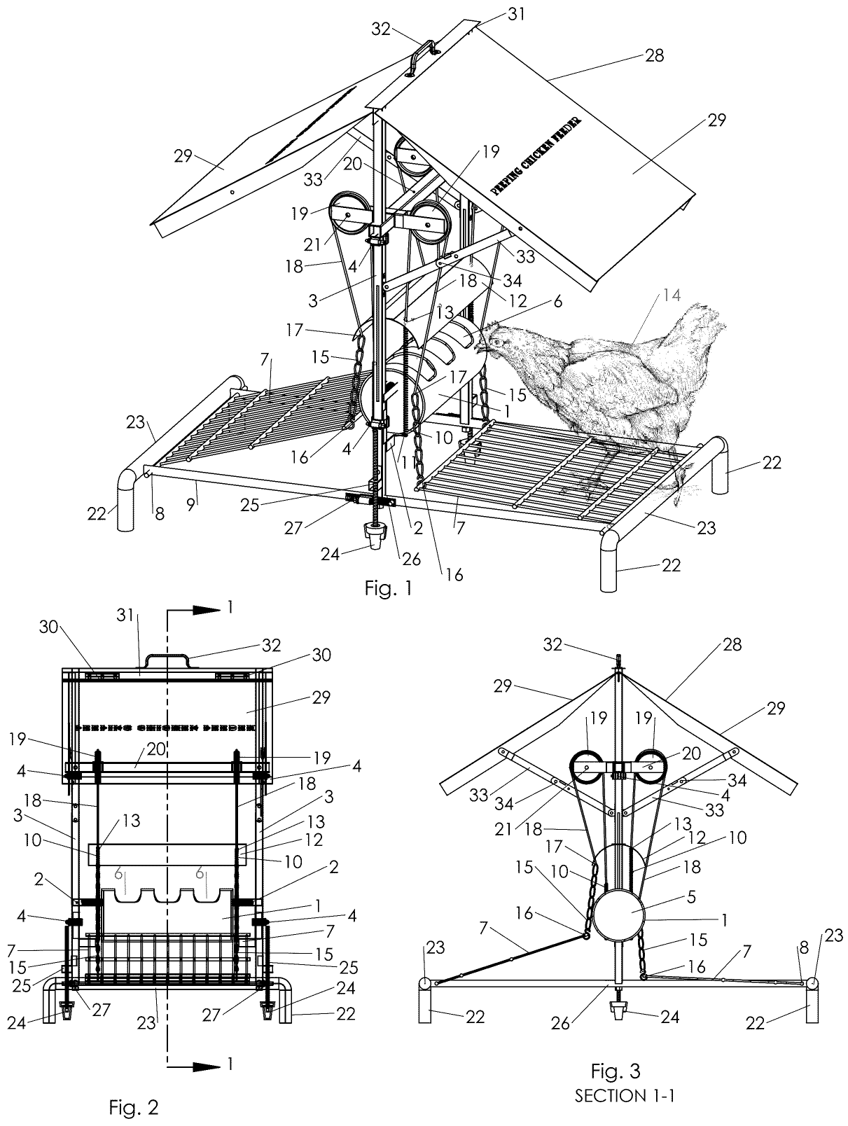

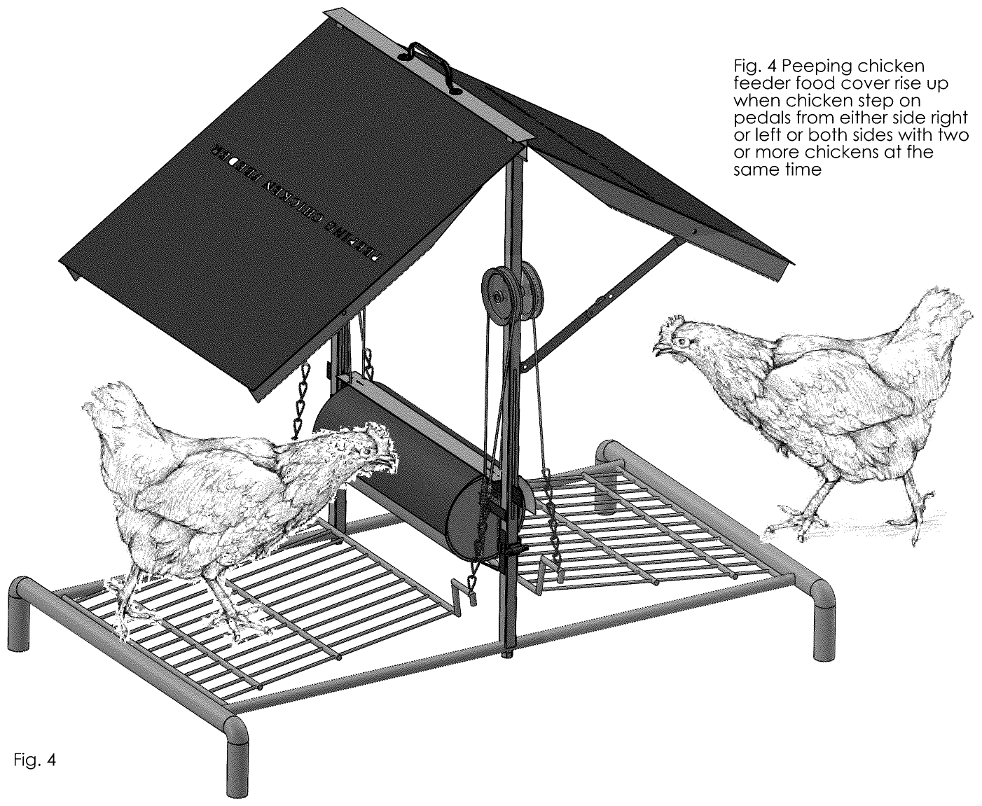

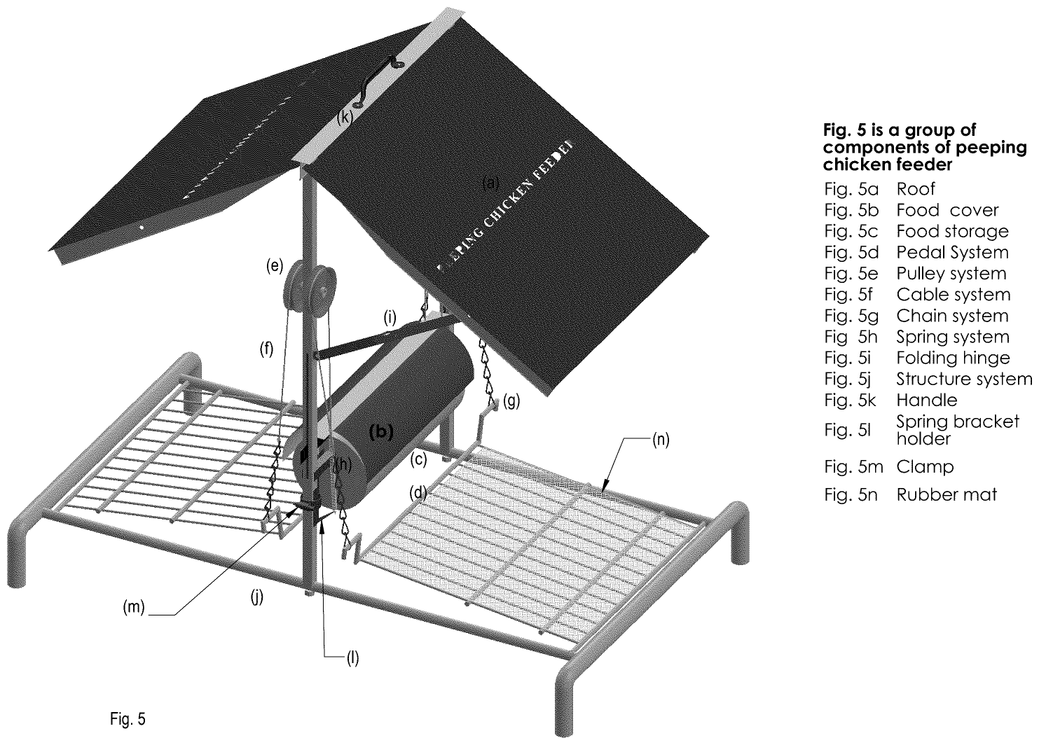

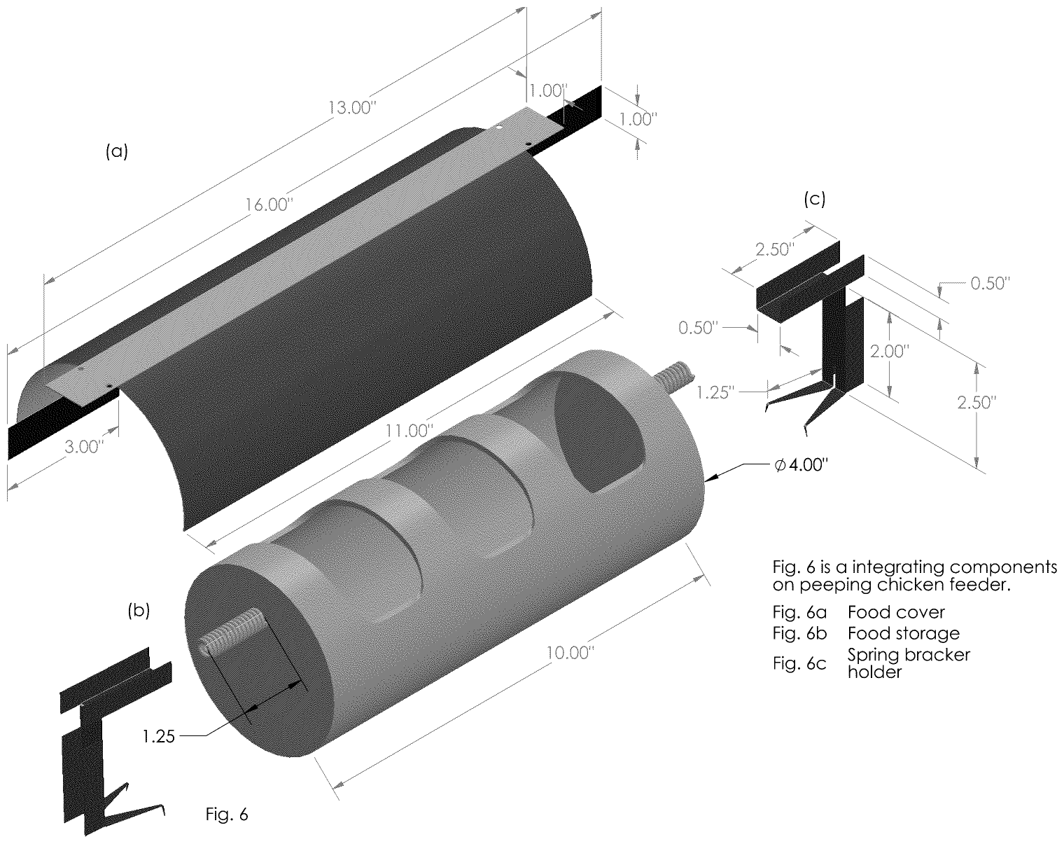

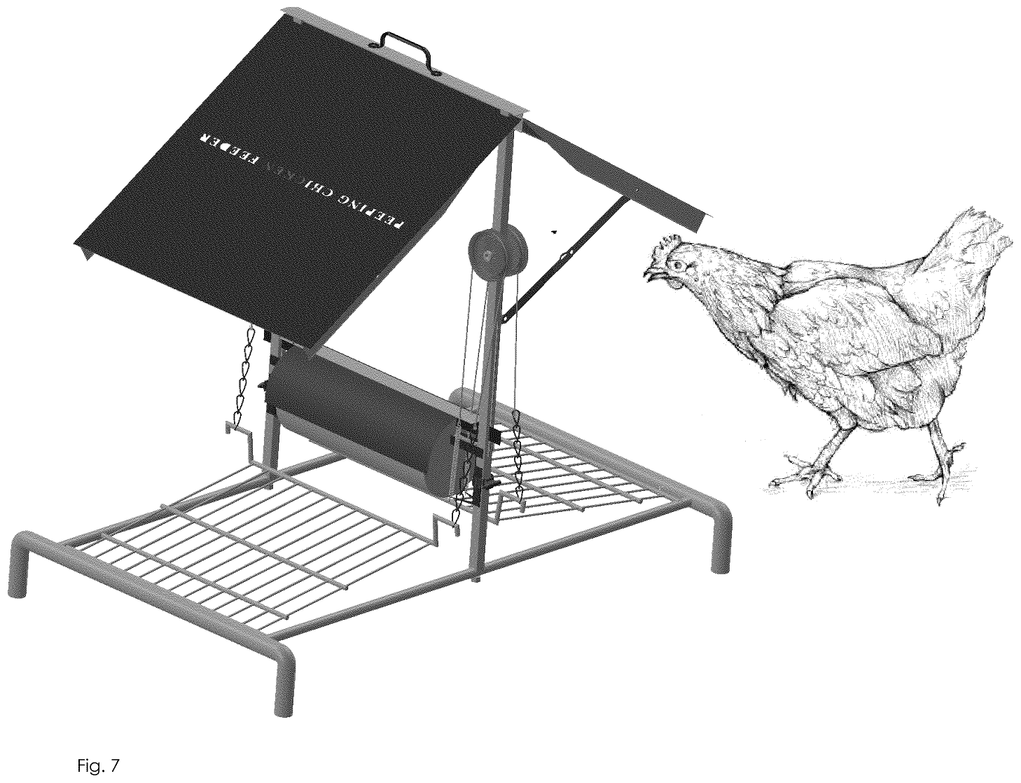

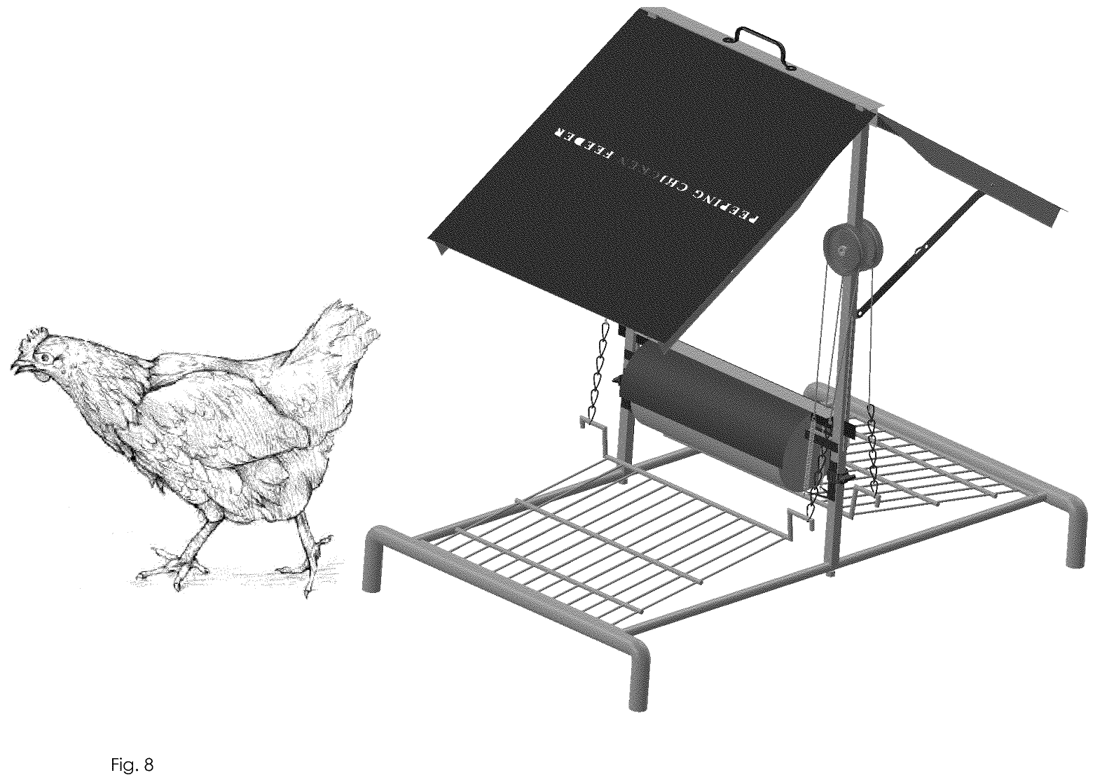

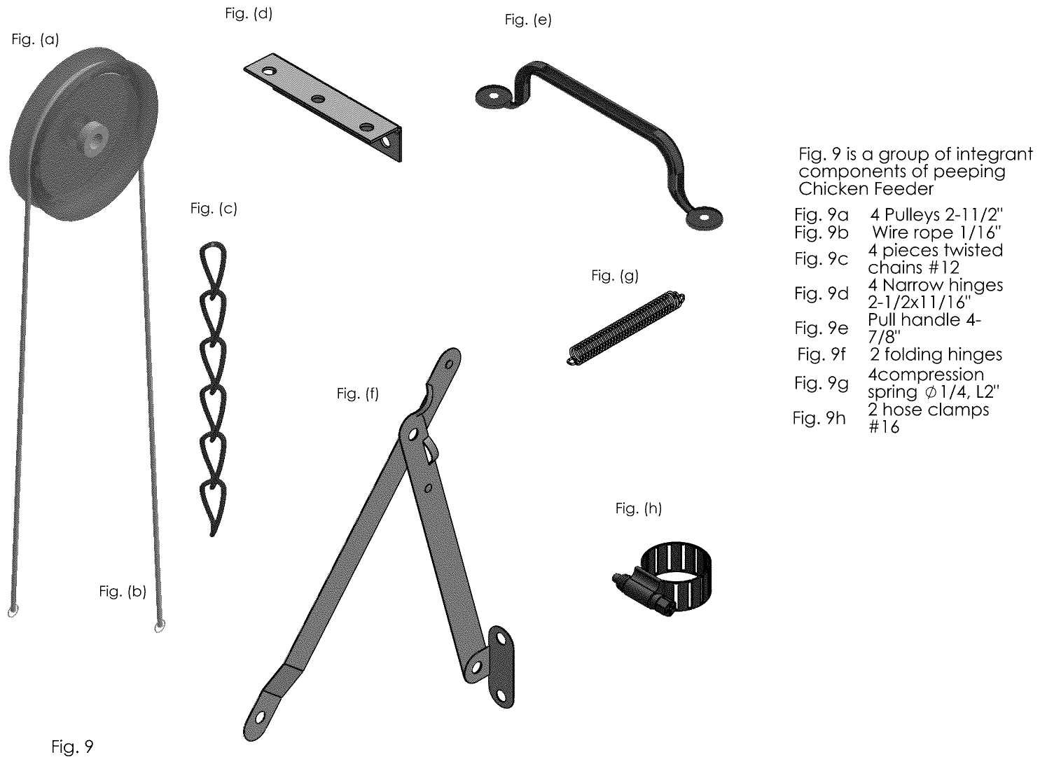

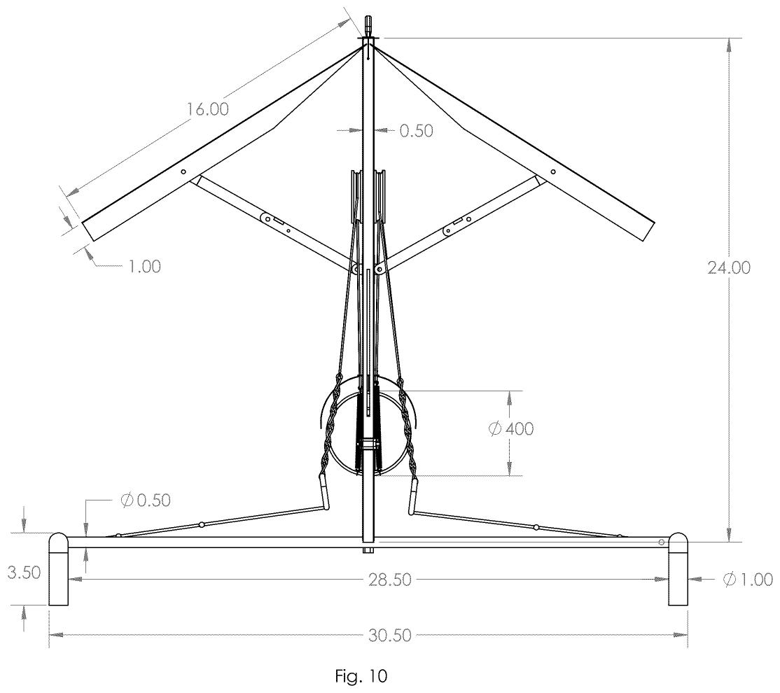

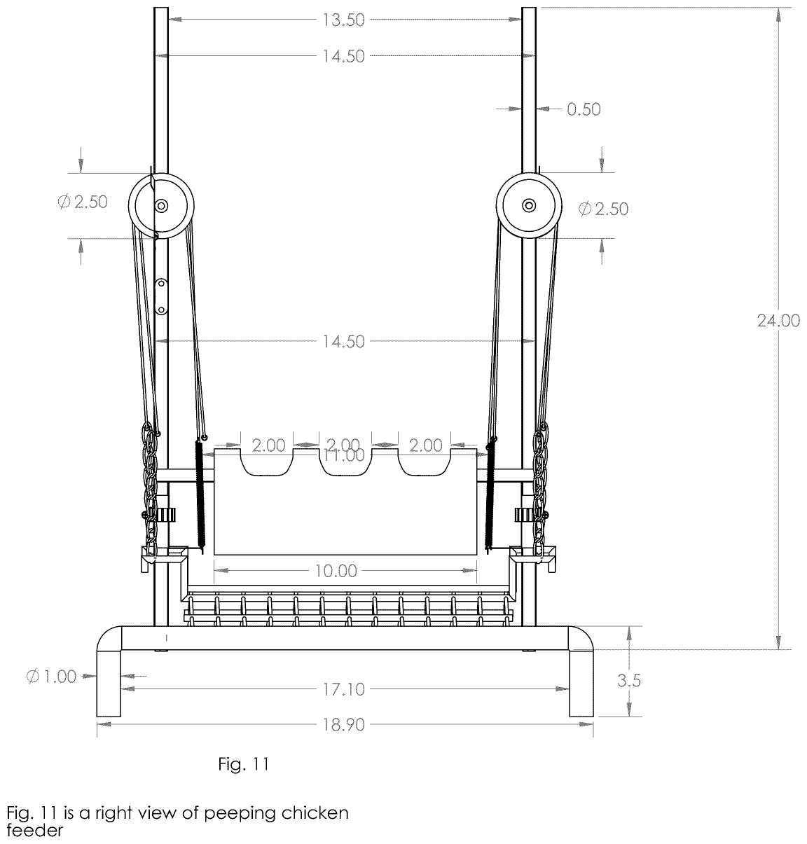

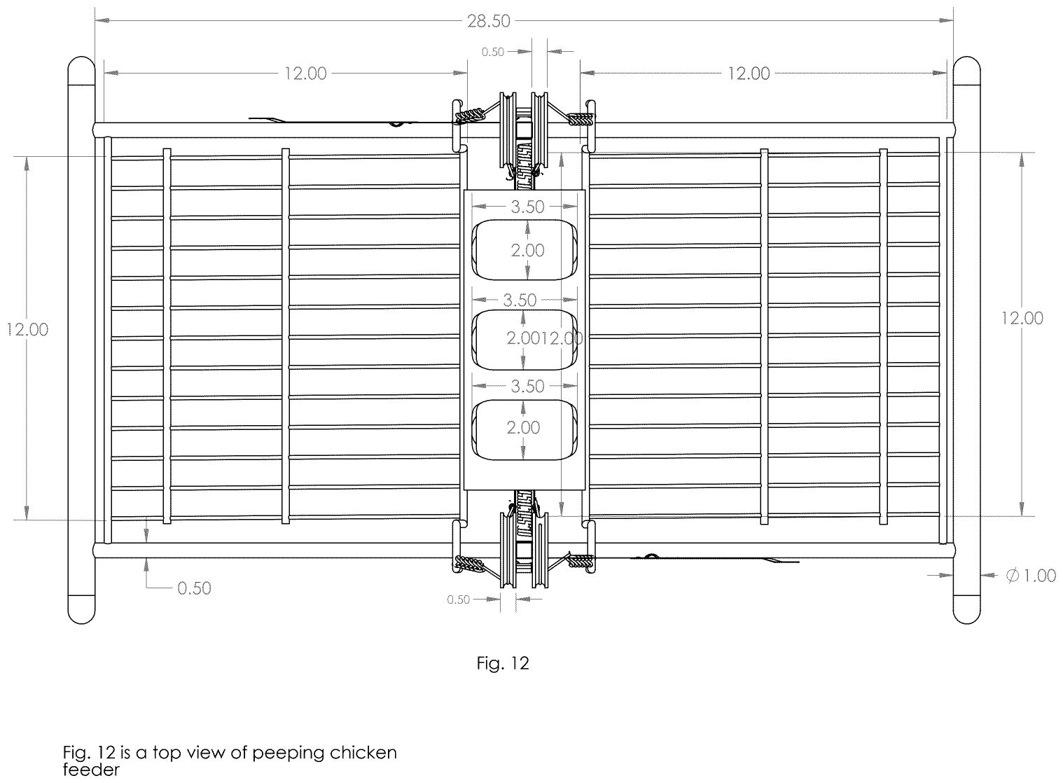

FIG. 5 and FIG. 9 show all components, including the structure, roof, and operational mechanical systems,

FIG. 10 and FIG. 11, and FIG. 12 show all dimensions of Peeping Chicken Feeder, it is mobile and can feed up to 3 to 5 chickens or more, and covers an area of around 3.25 sq ft.

1. A poultry feeder comprising:
a tubular main body (1) having a plurality of curved slot holes (6) at a common height; a curved cover (12) positioned over the slot holes; treadles (7) pivotally mounted at either side; chains (15), cables (18), and pulleys (19) operatively connecting the treadles (7) to the curved cover (12); and tension springs (10) configured to return the curved cover (12) to a closed position when no weight is applied to the treadles (7).

2. The poultry feeder of claim 1, wherein the tubular main body (1) is supported by brackets (2) mounted to a square tube (3) with tubing clamps and leveling is provided by adjustable screw feet (24).

3. The poultry feeder of claim 1, further comprising an inverted V-shaped roof (28) with hinged panels (29) for protecting the slot holes (6) from environmental elements, the roof (28) being foldable for transportation and storage.
